(19) United States
(12) Patent Application Publication
(10) Pub. No.: US 2004/0215550 A1
(43) Pub. Date: Oct. 28, 2004

(54) Simultaneous purchasing and selling of goods and services in auctions

(75) Inventors: Christopher William Preist, Bristol (GB); Andrew Robert Byde, Wales (GB); Claudio Bartolini, Menlo Park, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/735,776

(22) Filed: Dec. 16, 2003

(30) Foreign Application Priority Data
Dec. 17, 2002 (GB) 0229341.3

(51) Int. Cl. G06F 17/60

(52) U.S. Cl. 705/37

(57) ABSTRACT

A method of determining a bidding strategy for the simultaneous purchase of at least one individual service component (34) from one or more forward auctions (22a,22b), and the provision of a composite service (36) requested by a reverse auction (20), is described. The method comprises: identifying forward auctions (22a,22b) selling the at least one individual service component (34); identifying a reverse auction (20) requesting a composite service (36) comprising the at least one service component (34); determining a plurality of possible combinations of the identified forward (22a,22b) and reverse auctions (20); estimating the expected benefit of bidding in each of the plurality of possible combination of auctions (20,22a,22b) by use of likelihood models (44), wherein each likelihood model (44) establishes the likelihood of a particular bid succeeding in a given auction; and selecting the combination of auctions to increase the expected benefit for use as the bidding strategy.

### TECHNICAL FIELD

The present invention concerns improvements relating to the simultaneous purchasing and selling of goods and services in on-line auctions. It relates particularly, although not exclusively, to a method and system for participating in a set of reverse English auctions tendering service contracts, and a set of forward English auctions selling component services to build composite services which fill these service contracts.

### BACKGROUND ART

During the past decade, large companies have been encouraged by business consultants to focus on their core competencies. By trying to do everything (e.g. supply chain management, customer care, keeping the photocopiers running, producing good food in the office canteen) companies run the risk of being ‘jacks of all trades, but master of none’. As a result of this there is a danger that other smaller companies focused on the same core business will outperform their larger counterparts. To avoid that risk, and to become more competitive, many large companies are going through a process of ‘dis-aggregation’. In some cases, this can mean splitting a large company into several parts, each of which can focus on one core business (such as the recent move by Hewlett Packard to separate its test and measurement business from its computing business, creating a new company “Agilent”). In other cases, it can mean outsourcing more and more of a company's activities to other companies, maintaining only those activities in which it truly excels.

As the trend for outsourcing and dis-aggregation increases, much research and development effort has been directed to a new Internet-based application, that of “e-services”. E-services are virtual entities that provide a service over the Internet through an open standard interface. The service may be information, such as the latest stock prices, or it may be a virtual representation of some physical good or activity, such as a contract to transport a crate from one location to another. Because the service is offered through an open standard interface, any client familiar with the standard can use it. Furthermore, the output from one service can be fed directly into another service. This makes the creation of composite services and complex business processes which cross organisational boundaries possible. This has lead to the emergence of an important role in the virtual economy—the service composer. While some companies focus on their core competencies, other companies can focus on creating composite packages by obtaining services from different companies. This is not new—travel agents, among others, have done exactly that for years. However, there are problems with providing a composition service automatically and dynamically over a computer network. The reasons for this are set out below.

In an automated business to business transaction (whether on-line or via traditional channels), participants must go through three conceptually separate phases: “matchmaking”, “negotiation” and “service execution and delivery”. These three phases are now described.

Matchmaking is the process of putting service providers and service consumers in contact with each other. For matchmaking to take place, service providers that wish to be dynamically located via a computer network must publish details of themselves, and service consumers wishing to locate such services must search for these details. The service providers will advertise a service description, i.e., a formal specification of the nature of the service they offer. This information will usually be held in a central matchmaking directory. Some of the services advertising themselves for matchmaking will be simple end-providers that can be negotiated with directly. Others may be brokers, auction houses and marketplaces that offer a central location for negotiating with, and selecting amongst, many potential providers offering similar services.

When a company (i.e. a service consumer) wishes to locate a service provider of a certain type, it queries a matchmaker with a service request. The matchmaker returns a set of Uniform Resource Locators (URLs) to negotiations with appropriate service providers. In some cases, these negotiations will be one-to-one, while others may be auctions, exchanges, etc. Each pointer may also have a contract template associated with it, showing the associated terms and conditions of the negotiation. Of course, some of these contract terms and conditions may be uninstantiated or semi-instantiated, and therefore open to negotiation.

After the matchmaking phase, a service consumer may be faced with a variety of potential negotiations. Its aim now is to procure the best service, taking into account factors such as price, speed of delivery, etc. To do this, it will participate in one or more of these negotiations. Different negotiations will have different market mechanisms, i.e., different sets of rules determining how the negotiation should take place. The simplest mechanism consists of a single service, offering itself at a fixed, non-negotiable, price. Other mechanisms might involve entering into one-to-one bargaining with potential customers, conducting auctions, or posting the availability of services through exchanges. As a result of the negotiation phase, the participants agree a contract with terms and conditions that give each participant certain rights (such as the right to use a certain service) and obligations (such as the obligation to pay a certain price).

Once the terms and conditions of service execution have been agreed by the participant to negotiation, service execution can start. Service execution involves interaction between the service provider and the service consumer, both parties acting in accordance with the terms and conditions established during the negotiation process. Service delivery then takes place.

Matchmaking is traditionally viewed as a look-up process to find service providers able to meet a service consumer's needs, prior to the requestor selecting and/or negotiating with them. However, if the virtual economy is to encourage dynamic service composition, more flexibility will be necessary at the matchmaking stage. For instance, a service provider could have some idea of the general services it is interested in offering, but not know the full details. At any given time, it could estimate these details based on the current state of markets. In this type of scenario, the matchmaker must play a more active role. It must route potential service requests to service composers, which then respond with a dynamic service advertisement detailing the closest service to the request they can offer. This advertisement should not be treated as a binding contract—it is simply an estimate based on the current market situation. Negotiation would be required to reach a binding contract.

In the context of dynamic service composition, additional services (such as the provision of insurance) may be imposed on the service description. The service consumer will know that these additional services will be filled by subcontractors found by the service composer, but it will not know a priori who will provide these additional services. The service composer needs to be able to dynamically negotiate with potential subcontractors to determine exactly who will perform these additional services. Service composers must take into account any restrictions that potential customers may wish, in order to place constraints over who provides the additional services. For example, a consumer may want to ensure that all subcontractors are members of appropriate trade bodies. For this reason, the service provider may need to give information to the consumers during the matchmaking process detailing the names and/or details of potential subcontractors.

In the negotiation phase, the service composer may be involved in many inter-linked negotiations. For any single bundle of services (e.g. flights, transfers from the airport, hotel rooms, insurance), the service composer will be involved in at least one (but more likely many) negotiations to acquire instances of each service type. Furthermore, the service composer may be involved in simultaneous negotiations to purchase alternative bundles of service components, in an effort to find which bundle is best. It would ideally wish to do this in a non-committing way, that is, to be able to withdraw from negotiations for purchasing individual service components if the bid price becomes too high for it to make a profit. However, some forms of negotiations (such as auctions) require participants to make a commitment when placing a bid. When participating in negotiations of this kind, the provider of the composite service must take care to avoid buying incomplete or overly large bundles of service components. Furthermore, the service composer may be simultaneously negotiating with potential clients. In this case, it must trade off its expectation of winning such negotiations against any commitments it makes in the negotiations to purchase service components.

A service composer buying component services, combining these components and then selling the combination of components as a composite service, is taking a risk. If they enter into an agreement with one or more sellers of component services prior to agreeing with a buyer, they may end up purchasing unwanted component services. Similarly, if they enter into an agreement with the buyer of a composite service prior to buying the service components, they may be forced to renege on the contract and could potentially lose vast sums of money. Furthermore, with the increasingly widespread adoption of auctions and reverse auctions in electronic commerce, the problem becomes even mole risky. When placing a bid in an auction (or an offer/proposal in a reverse auction) the parties are obliged to honour the bid if it is accepted, but the bidder/offeror does not know whether the bid or offer will actually be accepted. This has led to the situation whereby businesses engaged in service composition do not tend to engage in both forward and reverse auctions simultaneously. Instead, they aim to get a provisional commitment from at least their buyers or their suppliers.

Work has been carried out on the problem of the simultaneous automated purchase of heterogeneous component services in an auction environment in response to a request for a composite service. Automated bidding is usually achieved by building a software agent that acts on behalf of a consumer and is given capabilities such as the ability to search on-line auctions, to negotiate with sellers and to make purchases autonomously. The Trading Agent Competition (“The 2002 trading agent competition” Peter Ston et al., in Proc. 14th Innovative Applications of Artificial Intelligence Conference 2002) presents a problem where an agent must participate in several simultaneous actions to purchase flights, accommodation, and entertainment. Successful agents in this competition include ATTac (“An adaptive autonomous bidding agent”, Peter Stone et al., in Proc. of the 5th International Conference on Autonomous Agents, pp. 238-245, Montreal, Canada, 2001,) and SouthamptonTAC (“Designing a successful trading agent”, M. He and N. Jennings, in Proc. 15th European Conference on AI (ECAI-2002), pp. 8-12, 2002). However, none of these methods enable the simultaneous negotiation with buyers and sellers though on-line forward and reverse auctions.

An object of the invention is therefore to provide a method for automatically carrying out simultaneously negotiations with both buyers and sellers in on-line forward and reverse auctions.

### SUMMARY OF THE INVENTION

According to a first aspect of the invention there is provided a method of determining a bidding strategy for the simultaneous purchase of at least one individual service component from one or more on-line forward auctions, and the provision of a composite service requested by an on-line reverse auction, the method comprising: identifying forward auctions selling the at least one individual service component; identifying a reverse auction requesting a composite service comprising the at least one service component; determining a plurality of possible combinations of the identified forward and reverse auctions; estimating the expected benefit of bidding in each of the plurality of possible combination of auctions by use of likelihood models, wherein a reverse auction is modelled as a negative forward auction and each likelihood model establishes the likelihood of a particular bid succeeding ill a given auction; and selecting the combination of auctions which provides the highest expected benefit, for use as the bidding strategy.

Preferably, the determining step comprises determining all possible combinations of the identified forward and reverse auctions.

The method is applicable to the selling and purchasing of both goods and services (or a combination of goods and services), and therefore the term services is taken to include goods and/or services. Hereinafter, the term bid may refer to a bid in a forward auction, and to an offer in a reverse auction, unless explicitly stated otherwise. In addition, the term auction (unless explicitly stated otherwise) may refer to a forward auction, a reverse auction, or to a fixed-price sale or purchase.

As discussed in the introduction, it is very difficult to simultaneously negotiate the purchasing of services in forward auctions, and the selling of services in reverse auctions. The method of the present invention advantageously provides a method of automating this process so that a purchaser/seller knows which auctions to place bids in (or not to place bids in) in order to make the best profit he can. The recognition that a reverse auction may be modelled as a negative forward auction enables such an algorithm to be formulated. If a fixed-price sale or purchase is being considered, this is preferably modelled as an auction with 100% certainty of closing at a price p.

A further advantage of the method of the invention is that a prior commitment to purchasing one or more services may be made before a commitment is made to selling a composite service (or vice versa), provided that this is a risk worth taking, i.e., if the risk is outweighed by the expected benefit.

The method of the present invention is aided by the provision/use of likelihood models which specify the likelihood of obtaining service components, and selling a composite service, at a given price. Preferably a separate likelihood model is provided for each auction, whether it is a forward or a reverse auction. The method may include obtaining the closing prices of forward and reverse auctions for services of a similar type to the services of interest, and creating a likelihood model for each auction from the closing price information. As closing prices of auctions for certain services may not be available for use with the method, the likelihood of obtaining such services may be estimated by an expert.

The method may also comprise monitoring the status of on-line auctions and retrieving auction data from each auction, the auction data including the current price for on-going auctions, and the closing price in closed auctions in which the bidding strategy has been implemented, i.e., auctions in which bids and/or offers have been placed. The closing price in these closed auctions is preferably used to update the likelihood models for that particular auction, giving a more accurate model and therefore a more accurate estimate of the benefit of placing bids (or holding bids) in the possible combination of auctions.

The method of the present invention preferably includes using rules for determining which individual components may be used to form a composite service. The composite service may comprise a single service component. In a preferred embodiment of the invention, the rules may be used to reduce the number of possible combinations of auctions considered, and thus to provide a method that is more efficient and therefore faster to execute. The number of possible combinations of auctions considered malt be carried out by removing from the possible combinations of auctions, sets of auctions for which the individual service components do not match the composite service request. In this case, all of the sets of auctions considered in the considering step preferably include at least one reverse auction, and at least one forward auction offering an individual service which may be combined (or used singly) to form a composite service to fulfil the reverse auction request. This more efficient method may be further improved by advantageously ignoring any gain in expected benefit of the unplanned purchase of individual components, and the selling of composite services which satisfy each other. These steps may be carried out prior to placing bids in any of the identified auctions. This provides the benefit of being able to calculate the expected benefit of the possible combinations of auctions in advance, and there is therefore less chance of placing a bid that will lead to the purchase of an unusable component, or of making an unfulfilable offer in a reverse auction.

Preferably, the forward and reverse auctions are forward and reverse English auctions, respectively. In an English auction, the auctioneer commences with the lowest price that would be acceptable to the seller, and bidders are at liberty to raise their bids until there are no more offers. The winner of the goods is the bidder who has put forward the highest bid. In a reverse auction, potential suppliers must offer prices, undercutting the lowest current offer. An offer is binding if the auction closes and it is the lowest offer.

According to a second aspect of the invention there is provided a method of bidding as specified in claim 18.

Preferably the method of bidding is carried out by an agent. However, this method may be carried out by a separate software (or even hardware) module, and the bidding strategy provided to one or more agents to implement at the various auctions. The agent preferably places the bids to buy the service components as cheaply as possible, and if there are several reverse auctions for similar composite services, it will try to sell them for as much profit as possible given the competition. If it is outbid in a given auction, the agent preferably considers whether it should increase its bid in this auction, bid elsewhere, or try to withdraw from other related auctions and reverse auctions. The method may include not placing a bid, if the leading bid is already held by the agent.

According to a third aspect of the invention there is provided a system for determining a bidding strategy for the simultaneous purchase of at least one individual service component from one or more forward on-line auctions, and the provision of a composite service requested by an on-line reverse auction, the composite service comprising at least one individual service component, the system comprising: likelihood models for the forward and reverse auctions, each model being arranged to determine the likelihood of at particular bid succeeding in a given auction; and is processing means arranged to access the likelihood models; to consider a plurality of possible combinations of forward and reverse auctions; estimate the expected benefit of bidding in each of the plurality of possible combination of auctions by use of the likelihood models, wherein a reverse auction is modelled as a negative forward auction; and to select the combination of auctions which provides the highest expected benefit, for use as the bidding strategy.

The present invention may also be considered to cover a data carrier comprising a computer program arranged to configure a computer to implement the methods described above.

In a further aspect, the invention provide; method of determining a bidding strategy for the simultaneous purchase of at least one individual service component from one or more forward auctions, and the provision of a composite service requested by a reverse auction, the method comprising: identifying forward auctions selling the at least one individual service component; identifying a reverse auction requesting a composite service comprising the at least one service component; determining a plurality of possible combinations of the identified forward and reverse auctions; estimating an expected benefit of bidding in each of the plurality of possible combination of auctions; and selecting a combination of auctions for bidding in to increase a total expected benefit.

In a still further aspect, the invention provides a system for determining a bidding strategy for the simultaneous purchase of at least one individual service component firm one or more forward auctions, and the provision of a composite service requested by a reverse auction, the composite service comprising at least one individual service component, the system comprising: likelihood models for the forward and reverse auctions, each model being arranged to determine the likelihood of a particular bid succeeding in a given auction; and processing means arranged to access the likelihood models; to consider a plurality of possible combinations of forward and reverse auctions; to estimate an expected benefit of bidding in each of the plurality of possible combination of auctions by use of the likelihood models; and to select a combination of auctions for bidding in to increase a total expected benefit.

### BRIEF DESCRIPTION OF DRAWINGS

Presently preferred embodiments of the invention will now be described, by way of example only, with reference to the accompanying File, in which:

FIG. 1 is a diagram of a client-server system suitable for implementing the presently preferred embodiment of the present invention;

FIG. 2 is a flow diagram showing an overview of the method of simultaneously purchasing multiple services and selling a composite service according to the presently preferred embodiment of the invention;

FIG. 3 is a likelihood function showing the probability P(x) of buying a service component at a price x as used in the method of the present invention;

FIG. 4 is a graph showing individual service flights legs from London (LHR) to San Francisco (SFO) and Los Angeles (LAX) which are utilised in the implementation of a presently preferred embodiment of the invention to form a composite freight service; and

FIG. 5 is a flow diagram showing the steps of providing the composite freight service of FIG. 4.

### DETAILED DESCRIPTION OF PREFERRED EMBODIMENTS

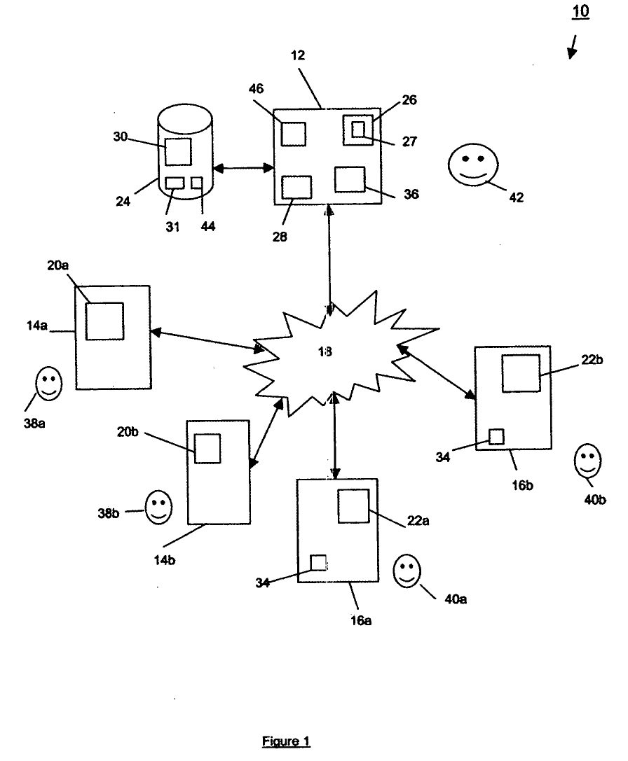

Referring to FIG. 1 of the drawings, there is shown a client-server system 10 which is suitable for implementing a presently preyed embodiment of the invention. The client-server system comprises a client computer 12 which is: connected to a plurality of servers computers 14a, 14b, 16a and 16b via the Internet 18.

Server computer 14a hosts a first reverse auction Web site 20a on behalf of a first composite service buyer 38a, and server computer 14b hosts a second reverse auction Web site 20b held on behalf of a second composite service buyer 38b. Server computer 16a hosts a first English auction Web site 22a held on behalf of a first service component seller 40a, and server computer 16b hosts a second English auction Web site 22b held on behalf of a second service component seller 40b. The reverse English auction Web sites 20a and 20b advertise service contracts (or Request for Quotes) on which a third party 42 is invited to make offers. The English auctions hosted by Web sites 22a and 22b offer for sage individual service components 34.

The client computer 12 is optionally connected to a database 24 by way of a further connection. The database stores rules 30 relating to how individual service components 34 can be combined to form a composite service 36, and also information 31 regarding closing prices of previously held forward and reverse English auctions for service components 34 and composite services 36, and likelihood models 44 which will be described later. Alternatively, the rules 30, information 31 and likelihood models 44 may be provided on the client corner 12.

Double headed arrows in the Figure indicate that data can be exchanged in both directions between the client computer 12 and the server computers 14a, 14b, 16a and 16b, and between the client computer 12 and the database 24.

At the client side of the system 10, there is; provided agent software 26 which implements an agent 27 (hereinafter the terms agent software and agent are used interchangeably). The agent 27 has the capability to place bids in English auctions 22a and 22b to purchase individual service components 34, to combine the service components 34 to form a composite service 36, and to offer the composite service to fulfil contacts (or RFQ's) advertised in reverse English auctions 20a and 20b. The agent software 26 also implements algorithms 28 and 46 for determining which of the forward and reverse English auctions to bid in.

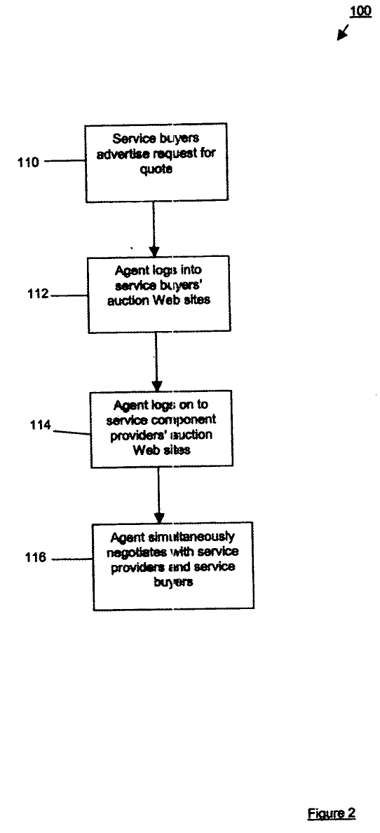

An overview of the method of the invention will first be described with reference to the flow diagram of FIG. 2.

The method 100 commences with service buyers 38a and 38b advertising at Step 110 a request for quote (RFQ) for specific services on their auction Web sites 20a and 20b, inviting service composers 42 to offer to fulfil the quote. The agent 27, which is monitoring the composite service buyers' Web sites 20a and 20b, logs on at Step 112 to service buyers' Web sites of interest. It may be, for example, that the service composer 42 is only interested in composing travel services for companies based in the United Kingdom, in which case only composite service buyers falling into this category will be considered by the agent 27. The agent 27 may log on to a composite service buyer's Web site at anytime within the duration of an auction (which can last from one hour to several weeks).

In Step 114, the agent 27 logs on to English auction Web sites 22a and 22b held by service component sellers 40a and 40b. Step 112 is not necessarily carried out before Step 114. That is, the agent 27 may log on to the English auction Web sites 16a and 16b before it is aware of the request for quotes advertised in Step 10.

The agent 27 then simultaneously negotiates at Step 116 with the service component sellers 40a and 40b (i.e. placing bids for service components) and the composite service buyers 38a and 38b (i.e. making offers to fulfil service contact) to make the highest profit it can. The ultimate aim of the agent 27 is to buy service components 34 from the service component sellers 40a and 40b at the lowest possible prices, and to sell the composed service 36 to the service buyers 38a and 38b at the highest possible price.

The service composer 42 (via the agent 27), may be notified of, and able to view, the bids of its competitors and respond with counter bids in a quest to be the lowest bidder and secure the service buyer's business, although the identities of the service composers may be hidden from one another for commercial reasons.

In the negotiation Step 116, the agent 27 must decide whether to enter into negotiation with the potential composite service buyers 38a and 38b and potential service component sellers 40a and 40b, and if so, which offers and bids it should place. For instance, should the agent 27 attempt to win the contracts offered by the first composite service buyer 38a and the second composite service buyer 38b, or just one contract? How should the agent 27 place its bids and offers to maximise the likely profit? The algorithm 28 that is able to make such decisions is now presented.

In order to specify the algorithm 28 that may be implemented automatically by an agent 27, certain assumptions are made on the nature of the environment in which the service composer 42 operates:

It is assumed that all transactions take place through English auctions, reverse auctions and fixed-price sales;

One-to-one negotiation or double auctions (i.e. where both sellers and buyers submit bids which are then ranked highest to lowest to generate demand and supply profiles) are not considered;

It is assumed that there are a sufficiently large number of buyers and sellers, and sufficient is stability in the environment, to allow statistical profiles of expected outcomes in auctions to be built.

It is assumed that the agent 27 is participating in a set of auctions, A (i.e., reverse auctions 20a and 20b, and forward auctions 22a and 22b). These auctions preferably all start at approximately the same time, but may finish at different times. Some of these auctions are forward auctions (auctions 22a and 22b), selling a single good or service 34, while others are reverse auctions (auctions 20a and 20b), requiring a single composite good or service 36.

The forward auctions are English auctions 22a and 22b with a fixed closing time. Participants 42 can place bids at any time, provided the new bid is a minimum increment, above the last bid. The units are chosen in which this minimum increment is one. This value is made for ease of presentation of the algorithm 28, and it might be different for different auctions. Utilising a different value for, would complicate the presentation of the algorithm 28, but not fundamentally change it. It is also assumed that the bid increment of each auction is very small with respect to the value of the good or service 34 for sale. At the auction closing time, the good or service 34 for sale is sold to the highest bidder 42 at the price they have bid.

The reverse auctions are reverse English auctions 20a and 20b with a fixed closing time. Auction participants 42 can place offers at any time, provided the new offer is a minimum decrement (chosen to be one as above) below the last bid. At the closing time, the lowest offeror 42 is given a contract to provide the required composite good or service 36 at the price they offered.

To simplify the mathematical notation used herein, reverse auctions are modelled as ‘negative’ English auctions. A contract to provide a good, g, is thus represented as the sale of a negative good, 5g. Participants 42 in the auctions place negative bids, which must increase (i.e. move towards zero) by at least the minimum bid increment. Fixed-price sellers are modelled as auctions with a known and certain closing price.

The following mathematical notation is used herein. Let x be an element or member of a set A. This is written x0A. If A is a subset of (i.e. contained in) B, this is denoted by AφB. The union of A and B can also be defined, which is written A_{χ}B. This means the set of all objects which are elements of A or of B, or of both A and B. Now define the intersection of A and B, denoted by A1B. This means the set of all objects which are in both A and B. The expression f: A→B means where f is a function from A to B, i.e., to each member a of A, f assigns a value f(a) in B. [symbol] means “there does not exist”. ∀ is read is “for all”. ∅ stands for the empty set, i.e. the set which has no members. Lastly, the relative complement A\B is defined, giving the set of all objects that belong to A but not to B.

Now let the technology, T, of the agent 27 consist of a set of rewrite rules 30, each with an associated cost. The rewrite rules 30 are of the form ({a} [symbol] {b₁, . . . ,bₙ},c) where a, b₁, . . . , bₙ are (non-negative) goods or services. The rule 30 is read as stating that the agent 27 has the technology to produce good a from the bag of goods b₁, . . . , bₙ at a cost of c. A bag of goods (not a set of goods) is considered because a composite service 36 may use several identical service components 34. Also added to T are all rules 30 of the form (∅z,1 {g, [symbol] g},0) for all goods g. These rules 30 represent the fact that the agent 27 can satisfy a contract, 5g, if they are able to generate a good, g.

Given a bag of goods G, G′ is a one-step rewrite of G at cost c if.

(A [symbol] B,c)∈T, B⊂G, and G′=A∪G\B

Gⁿ is a rewrite of G at cost c(Gⁿ) if it is a one-step rewrite of G at cost c, or there is some rewrite Gⁿ⁻¹ of G at cost c(Gⁿ⁻¹) such that Gⁿ is a one-step rewrite of Gⁿ⁻¹ at cost c(Gⁿ)−c(Gⁿ⁻¹). The definition holds for n∃1, with G⁰:=G.

Note that the rewrite relationship is not symmetric i.e., if G can be rewritten to create G′, it does not follow that G′ can be rewritten to create G. Moreover, the assumption is made that applying successive rewrites to a bag of goods will never result in the original bag. That is, [symbol] G such that Gⁿ=G, ∀nn>0.

Let W(G) be the set of all rewrites of G. To each possible bag of goods G there is associated a number ν(G), otherwise known as the exogenous valuation to the agent 27 of these goods. This defines the value the agent 27 receives from making use of these goods (and contracts, represented by negative goods) outside the auction environment explicitly represented. The exogenous valuation of a good may be positive, if it is easy to sell on and has an expected market price. It may be negative, representing the dumping cost, or zero, if the good has no value but can be freely disposed of. The valuation of a supply contact, 5g, will be negative, representing the cost of fulfilling the contract on the open market, or the de-commitment penalty associated with dropping the contract.

In the service composition environment, it is expected that the exogenous valuation of goods and contracts is going to be poor and that most of the agent's 27 profit will be made through sales in the reverse auctions. Hence, it is in the interests of the agent 27 to buy bundles in which the agent's technology can pair contracts won in reverse auctions with compositions of goods won in forward auctions.

The valuation V(G) of a given bag of goods, G, is given by:

$$V ( G ) = {max}_{{G}^{′} ∈ W ( G )} ( v ( {G}^{′} ) - c ( {G}^{′} ) )$$

In other words, it is the valuation produced by optimum application of the agents 27 technology on G.

Now a bid set is defined to be a pair (A, p), where AδA and p: A [symbol] Z is a price function (where Z is the set of all integers, and A is the set of forward and reverse auctions considered by the agent) is a price function, representing the price the agent 27 is bidding in each auction in A. Note that technically, the bid set is a “bid and offer” set, but for each of presentation it is referred to as a bid set.

The “utility” (i.e. the benefit) to the agent 27 of winning a bid set (A, p) is

$$u ( A , p ) = V ( A ) - {\sum }_{a ∈ A} p ( a ) .$$

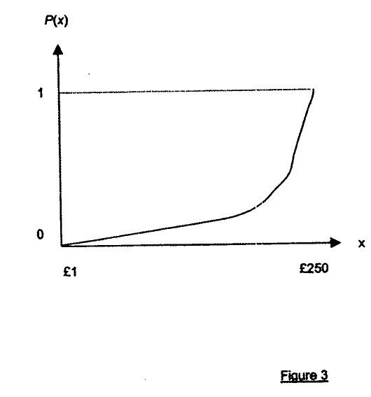

The agent 27 maintains a likelihood model 44 (Pₐ) of the expected outcomes of each auction, based on past performance of similar auctions. This is implemented by associating a price distribution Pₐ: Z [symbol] [0,1] to each auction a0A, representing the belief that, with probability Pₐ(p), auction a will close at price p. An example of a likelihood model (or function) 44 is shown in FIG. 3. The function P illustrates the probability of purchasing a good or service in a forward auction a for £1 is zero, and the probability of purchasing the same good or service in the same auction for £250 is one. That is, tie auction will certainly not be won if a bidder bids £1, whereas the bidder is certain to win if he makes a bid of £250. The agent's 27 believed probability that auction a will close at or above price p is given by Fₐ(p)=3_{p′∃p}Pₐ(p′). For subsets AδA, P_{A}(p) is defined to be the believed probability that the auctions in A will close at the prices specified by a price function p: A [symbol] Z:

P_{A}(P)=l_{a0A}Pₐ(p(a)) (1)

and likewise F_{A}, the probability that that the auctions in A will close at or above the prices specified by p:

F_{A}(p)=l_{a0A}Fₐ(p(a)) (2)

If the price in auction a is q, then the agent 27 believes that the probability of a bid at price p≧q winning is:

P_{win}(a,p,q):=Pₐ(p)/Fₐ(q) (3)

Similarly, for a collections of auctions A with current prices q:A→|(where | is the set of all real numbers) the probability of the auctions closing at prices p is:

P_{win}(A,p,q):=P_{A}(p)/F_{A}(q) (4)

A fixed-price seller is modelled as an auction with 100% certainty of closing at p which will guarantee a sale of a given good at a price p.

It is now considered how the agent 27 can use the beliefs defined in equations (3) and (4) to calculate information about expected future utility of deals it may win. Firstly, the notion of the expected utility E(B,A,q) of a set of auctions B, given a set of observed prices q and given that the agent 27 holds active bids in auctions A, is defined as follows:

E(B,A,q)=V(B)−C(B1A, q)−C(B\A, q+1) (5)

where the function C(S,q′) is the expected cost of wiring the auctions S at prices greater than or equal to q′:

$$C ( S , {q}^{′} ) = {\sum }_{{p}^{′} \geq {q}^{′}} {\sum }_{a ∈ S} {P}_{win} ( a , {p}^{′} ( a ) , {q}^{′} ( a ) ) {p}^{′} ( a ) \qquad ( 6 )$$

The expected utility of a set of auctions is thus the value of the bundle of components 34, minus the expected cost of winning the components in each of the auctions. The latter is calculated by using the believed probability (or likelihood) that the auction will finish at each given price, if the agent 27 places a bid at that price. The restrictive condition p′>q is imposed for auctions B\A in Equation (5) because it is known that the agent 27 does not hold bids in these auctions at prices q, and so has no probability of g at these prices.

The expression (5) gives some idea of the intrinsic value of a bundle of goods B, but is not the expected return for placing a single bid in the auctions in B. In general such a bid does not have an expected return: it is thus necessary to reason over complete strategies.

Consider the expected value (given that prices are currently q, and the agent 27 holds the active bids A) of the following strategy. The agent 27 chooses a set of auctions B and for all future time steps, will always bid on any elements of B in which it does not hold active bids. If the agent 27 sticks to this commitment, then its future choices are known, and so precise formulae for expected return can be calculated.

Let S be a possible set of auctions that the agent 27 may win using the above strategy, i.e., BδSδA_{χ}B. The probability that the auctions S\B will not be outbid, while the auctions A\S are, is:

P_{ref}(S,A,q)=(F_{A\S}(q+1)P_{S\B}(q))/F_{A\B}(q).

Given this eventuality, the expected utility is evaluated in the same way as (5), except that instead of V(B), the value obtained is V(S), and additional costs are incurred for each auction in S\B that is won.

It follows that the expected value for following the commitment to B is:

$${E}_{c} ( B , A , q ) = E ( B , A , q ) + {\sum }_{B ⋐ S ⋐ A ⋃ B} {P}_{ret} ( S , A , q ) ( ( V ( S ) - V ( B ) ) - {\sum }_{a ∈ S / B} q ( a ) ) . \qquad ( 7 )$$

The terms in the above expression for which S=B are the desired outcomes. The other terms correspond to obtaining some non-empty collection S\B of goods that do not contribute to the desired bundle B, although they could still provide positive value. It is anticipated that in the service composition arena, where goods/services tend to complement one another, the slight increase of V(S) with respect to V(B) will not be large enough to compensate for the increase in costs Σ_{a∈S\B}q(a), and each of these terms would have a negative impact on the expected value of the commitment This will certainty be the case for negative goods appearing in S\B, representing the possible winning of a reverse auction not appearing in the desired bundle (and therefore the need to satisfy it on the open mark or to pay the de-commitment penalty).

The algorithm 28 proposed herein is that at each time step the agent 27 calculates the commitment to auctions B which has largest expected utility, E_{c}(B,A,q), given the currently held bids A and prices q, and places the minimal bids required to take the lead in B\A (i.e., the set of auctions B not including A, as the agent 27 already holds bids in A).

In practice this means the agent 27 will initially identify the set of options which maximise its a priori expected utility. These options will consist of a reverse auction for a given composite service 36, together with a set of English auctions for the required components 34. It will place bids in these forward/reverse auctions and will continue to compete in these auctions, placing more bids when outbid. However, if sufficient competing bids are placed to reduce the expected utility of this set of auctions, then it may change to another set of auctions which can generate the same composite service. The agent 27 will do this if the expected gain from changing to this new bundle outweighs the expected cost of currently held bids which appear in the old bundle but not in the new bundle. If competing bids are placed in one of the reverse auctions the agent 27 is participating in, and the expected value f that auction decreases sufficiently, it may withdraw from that reverse auction. The agent 27 may use the associated forward auctions in another option, or may withdraw from them as well.

In practice, if the number of auctions is large, it will be difficult to evaluate Equation (7) for every alternative bundle given realistic computational resource bounds. Ideally, if there existed perfect information and unlimited computation time, the outcome of Equation (7) could be calculated accurately. However, if the algorithm 28 is to be used in realistic circumstances, it is necessary to develop a simplified version which is more tractable. The efficiency of the algorithm 28 can be improved by making two simplifying assumptions:

1. Every possible bundle of auctions is not considered, but attention is restricted to a promising subset of these bundles. Only those bundles which can be transformed using the rewrite rules 30 into the empty set, (i.e., the candidate class) is focussed upon. The promising subsets will contain at least one reverse auction, and at least one English auction selling exactly the correct components to satisfy the request for quota This is different to the aforedescribed method, where every combination of auction is considered by the algorithm 28, leading to possible subsets containing perhaps only a single auction, or a reverse auction together with a set of English auctions selling individual components which would not satisfy a request for quote.

2. When considering the expected utility of switching to a possible bundle, any utility gain of the unplanned purchase of items in the set of auctions S\B, beyond their immediate exogenous utility, is ignored. In other words, the algorithm 28 ignores any utility gain from the unplanned purchase of goods 34 and contracts which satisfy each other.

The first assumption is valid if it is assumed that the exogenous valuation of any good 34 or set of goods will always be less than or equal to their purchase price in the auctions being considered by the agent. This also applies to negative goods⊃the cost of satisfying a contract exogenously should be greater than or equal to the contract price in a reverse auction. In this situation, no utility can be gained by purchasing a good or set of goods for the purpose of disposing of them exogenously (i.e., it is not worth buying goods in auctions to sell on the open market for the exogenous valuation). Because of this, any set of auctions will always contain a subset of auctions with equal or higher expected utility which can be transformed via the rewrite rules 30 into the empty set.

Note that the first assumption can be made without loss of generality. If a particular good b has an exogenous valuation v(b), which can at limes be greater than its purchase price in an auction, an endogenous fixed-price buyer willing to: purchase b for v(b) can be added to A, the set of auctions considered by the agent (this is represented as an English auction for 5b with a 100% probability of closing at −v(b)). If a set of goods {b₁, . . . ,bₙ} is super-additive (i.e. v({b₁, . . . ,bₙ})>v(b₁)+ . . . +v(bₙ) this is represented as a rewrite rule ({q} [symbol] {b₁, . . . ,bₙ}, 0 together with a fixed-price buyer for q at v({b₁, . . . ,bₙ}).

The second assumption allows simplification of equation (7) to give:

$${E}_{c} ( B , A , q ) = E ( B , A , q ) + {\sum }_{a ∈ A / B} {P}_{win} ( a , q ( a ) , q ( a ) ) ( v ( a ) - q ( a ) ) \qquad ( 8 )$$

This is believed to be, in almost all circumstances, a good approximation for equation (7). It is very unlikely that an agent 27 will decide to withdraw from a reverse auction and set of forward auctions able to satisfy it, and then win all the relevant auctions because no-on else bids in them. Hence the positive contribution of this to the expected utility will be small and therefore safe to ignore. Note that because of this, equation (8) will yield a value of E, slightly less than or equal to that given by equation (7).

The above two assumptions greatly simplify the computation of the optimal bid set. It is no longer required to calculate the endogenous valuation of all bundles, only those in the candidate class. Calculation of (8) for a given bundle (only needs one endogenous valuation, as opposed to the 2^{|A\B|} valuations required by Equation (7).

Furthermore the candidate class of bundles, together with their endogenous valuations, can be generated prior to participation in the auctions provided that the set of auctions is known It is sufficient to exhaustively backward-chain the rewrite rules 30 from the empty set, while simultaneously keeping track of the incremental cost of transformation. This will generate all bundles which can be transformed into the empty set, together with their cost of transformation. The (negative) endogenous valuation of a given bundle will simply be the minimal cost of transformation to the empty set. An algorithm (in pseudo-code format) 46 for the computation of the candidate bundle set and for the valuation of the bundles is now presented.

The pseudo-algorithm 46 presented below computes all the candidate bundles (i.e. the promising subsets of auctions which contain a reverse auction and a set of forward auctions that sell components which, when combined, will satisfy the request for quote advertised in the reverse auction) while associating a valuation to the bundles. Let C be the set of the candidate bundles and Wand X be the working sets to contain bundles that will end up in C after having generated other candidate bundles. O is tile bag containing all the current offers to fulfil a contract in a current reverse auction that are available to the agent 27. Notice that the same basic component 34 might appear more than once in O. T is the set of the rewrite rules 30. Given a bag of goods or bundle G, V(G) is the valuation of the bundle. J(G) is the set of the justifications for G. A justification for a bundle is a couple (G′,r) such that where G is a rewrite of G′ through r. Given a rule r0T, c(r) is the cost associated with the rule. Let H be the bag of goods or services that appear as head of the rules in T.

C=∅ (Initialise the candidate set to be the empty set)

V(∅)=0 (Set the valuation of the empty set bundle to 0)

W=(∅) (Initialise the working set W to contain the empty set)

For each good or service currently requested in a reverse auction o in O

For each bundle G in W

Let G=G_{χ}{o, [symbol] } (Create a new bundle G′ by adding the couple {o, [symbol] } to the bundle G)

Let J(G)=∅ (Initialise the justification set of G′ to be empty)

Let W=W_{χ}{G′} (Add the new bundle G′ to the working set W. W now contains all achievable bundles of the kind {o, [symbol] o})

Repeat

Let G be a bundle in W

For each (positive) element a in G

Let RφT be the set of rules having a as head

For each r in R

Let D be the body of r

Let G′=G_{χ}D\{a} (Create a new bundle G′by adding the elements of the body of r to G and removing a from it)

If G included in O_{χ}H then (If the bundle G′ now only contains elements that are either currently requested in a reverse auction or obtainable through rewriting, i.e., they are the head of one of the rules)

Let J(G′)=J(G′)_{χ}{(G,r)} (Add the bundle G and the rule r as a new justification for G′)

Let W=W_{χ}G′\G (Add G′ from the working set W, remove G)

Let X=X_{χ}G (Add G to the working set X)

Until W=∅(X now contains all the candidate bundles with their justifications).

This last section of the algorithm 46 is guaranteed to terminate because of the assumption that continuing to apply rewrite rules 30 to a bundle will never result in the original bundle.

Now the valuations for the bundles are computed from their justifications:

Repeat

Let G be in X such that for all (G′, r) in J(G), G′ is not in X(G is a bundle in X for which none of the bundles that are used as its justification, i.e., the rewrites of G, appear in X. If G is not the empty set, G is guaranteed to exist in X by the assumption set out previously).

If J(G)=∅ then let V(G)=0 (If G dries not have justifications, set its valuation to 0)

Else

V(G)=max_{(G′,r) in J(G)}(V(G′)−c(r)) (For each bundle G′ that appears as a justification for G, consider its potential valuation for G the difference between the valuation of G′ and the cost of rewrite of G into G′, c(r) in the formula above. Set the valuation for G to be the maximum of these potential valuations. Notice that the valuation of G′ has been assigned since G′ is not in X)

Let X=X\{G} (Remove G from the working set X)

Let C=C_{χ}{G}(Add G to the candidate set C)

Until X=∅ (At this point C is the candidate set, and for each candidate bundle a valuation has been assigned).

By way of example only, a scenario is now presented that demonstrates the need for sophisticated simultaneous negotiation in both forward 22a and 22b and reverse 20a and 20b English auctions, and which utilises the simplified algorithm 46.

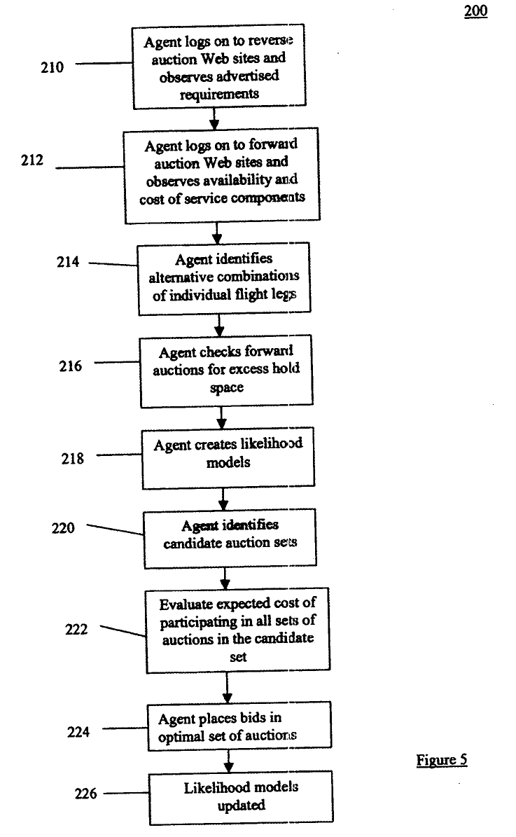

“FreightComposer” is an imaginary transit company that ships goods around the world on behalf of its customers. Unlike some other transport companies, it owns no transport infrastructure. Instead, it exploits cheap last-minute sales of excess hold space to meet the needs of its customers. Because it cannot guarantee that hold space will be available on a particular route, it may connect together several flight legs 34 to get the package to its destination and may thereby perform the function of a composite service provider 42. While it may not be the quickest service, it aims to be the cheapest. The method 200 implemented in order to provide a composite service is shown in FIG. 5, and will now be explained.

FreightComposer 42 acts in two distinct sets of markets. In the markets for end-to-end cargo services, it acts as a potential seller. In this respect, FreightComposer's agent 27 logs on at Step 210 to reverse auctions 20a and 20b, and observes the advertised requirements of potential customers (i.e., composite service buyers 38). In the markets for hold space on flights (and possibly ships), the agent 27 acts as a potential buyer. In this respect, it logs on at Step 212 to forward auction Web sites 22a and 22b, and observes the availability and cost of different options in these markets. Some sellers 40 will sell hold space at a fixed price, rather than by way of forward auctions 22.

In its role as a service composer 42, FreightComposer must (a) understand requirements of the potential customers which are currently requesting services in end-to-end cargo markets and identify a service which could meet their needs; (b) identify the alternative ways this service can be created from component services (i.e. hold space on specific flights); and (c) identify potential sellers of these component services in the markets for hold space on flights. By analysing the various markets, FreightComposer can determine potential trading options. Each option will consist of the following:

A potential buyer, or set of buyers 38a and 38b who are currently requesting a service in the end-to-end cargo marketplaces;

A service specification which meets the needs of these buyers;

One or more alternate decomposition-i of this service into component services; and

A list of sellers 40a and 40b in thc markets for hold space who are offering to sell individual component services 34 appearing in these decompositions.

For example, assume that the FreightComposer agent 27 observes (dung Step 210) a first “Request For Quote” on-line reverse auction 20a for sending a 1 tonne crate from London to San Francisco, with the best offer currently at £230, and a sec on-line reverse auction 20b for sending a 1 tonne crate from London to Los Angeles (during Step 212), with the best offer currently at £260.

Using its database 24 of rules 30, the agent 27 identifies at Step 214 alternative combinations of individual flight legs 34 that might potentially meet these needs. The agent 27 identifies a direct route from London (LHR) to San Francisco (SFO), together with alternative routes via Chicago (ORD), New York (JFK) and Boston (BOS). It finds no appropriate direct flight from London to Los Angeles (LAX), but finds flights from Chicago to Los Angeles, and from San Francisco to Los Angeles. The rewrite rules 30 for this particular example are given below:

1. sfo [symbol] {a, b}

2. sfo [symbol] {c}

3. ord [symbol] {e}

4. ord [symbol] {d}

5. sfo [symbol] {ord,f}

6. la [symbol] {ord, g}

7. la [symbol] {sfo, h}

Looking at the first rewrite rule, a journey from London Heathrow to San Francisco may be undertaken by combining individual flight leg a from London Heathrow to Boston, and another individual flight leg b from Boston to San Francisco. The second rewrite rule means that a journey from London Heathrow to San Francisco may comprise direct flight.

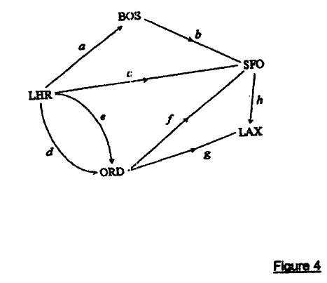

The agent 27 then checks at Step 216 the forward auctions on Web sites 22a and 22b for excess hold space, and finds that appropriate auctions exist for all legs except LHR to JFK. Each auction is for exactly 1 tonne of hold space. The individual flight legs 34 available are shown in FIG. 4.

The agent 27 now has an option consisting of a reverse auction 20a for a shipment {LHR-SFO}, three alternative ways of generating the required service from component services ({LHR-SFO}, {LHR-ORD & ORD-SFO} or {LHR-BOS & BOS-SFO}), and potential sellers 40a and 40b for each of the component services. It al so has an option consisting of the reverse auction 20b for a shipment {LHR-LAX}, and four alternative ways for generating the component services (e.g. {LHR-SFO & SFO-LAX} or {LHR-ORD & ORD-LAX}).

Based on the past histories of similar auctions to the ones that were found at Step 216, the agent 27 creates at Step 218 likelihood models 4t from closing prices 31 of previously held auctions. In addition, the agent 27 creates beliefs 44 about the expected distribution of the two reverse auctions 22a and 22b it is considering participating in, again from the closing prices 31 of previously held auctions. If the likelihood models have been created in advance, Step 218 will comprise retrieving the likelihood models 44 from a database 24. The reverse auctions are represented by negative prices in the likelihood models. This signifies that FreightComposer 42 will receive money if the agent 27 wins an auction.

Imagine that the closing prices 31 of previously held forward auctions for individual flight legs, and reverse auctions for composite flights, are uniformly distributed over the following sets:

a:{40,45, . . . , 135, 140} (LHR to BOS)

b:{20, 25, . . . , 95, 100} (BOS to SFO)

c:{130, 135, 140, 145, 150} (LHR to SFO)

d:{50, 55, . . . , 105, 110} (LHR to ORD)

e:{80, 85, . . . , 115, 120} (LHR to ORD)

f:{30, 35, . . . , 65, 70} (ORD to SFO)

g:{20, 25, . . . , 135, 140} (ORD to LAX)

h:{70, 75, 80, 85, 90} (SFO to LAX)

5la:{−250, −240, . . . , −200, −190}

5sfo:{220, −210, −200, −190, −180}

Now that the agent 27 has identified possible components that may be combined (or used singly) to form a requested composite service, it is ready to negotiate simultaneously with the buyers and sellers. Before bidding begins, the agent 27 holds no bids. It is assumed that the current price function q₀ lies just below all of the above prices. For the purposes of this example, it is also assumed that the cost of composing a service 36 is zero, and hence the rules 30 have no associated costs.

The algorithm 46 described above is used to identify at Step 220 the candidate sets. That is, the sets of auctions containing at least one reverse auction, and at least one service component 34 which, when combined (if there are multiple service components 34) or used singly, form a composite service 36 which can be sold in thc reverse auction to fulfil a request for quote, for example. As the agent 27 has not yet pal bids in any of the suctions 20a, 20b, 22a and 22b, equation (5) is wed to evaluate at Step 22 the expected cost of participating in all of the sets of auctions in the candidate set. This allows the determination of which set has the optimal expected payoff. In this case the optimal set is {d, g, c, 5sfo, 5la}: it has an expected purchase cost of 80+80+140−200−220=−£120. Hence., participating in these auctions and committing to purchase the complete bundle of individual flights from London to Boston, Boston to Los Angeles, and London to San Francisco, and t sell the composite services requested for London to San Francisco and London to Los Angeles, gives an expected payoff of £120. The agent 27 therefore places at Step 224 initial bids in these five auctions.

Now assume that the auctions have progressed, so that auction g now has a leading bid of £105 held by another party (giving an expected purchase price of £125) and the agent 27 holds auction c with a bid of £130 (still giving an expected purge price of ±140). The agent 27, at each time step, observes the bids, B, it currently holds in all the forward and reverse auctions, together with the current auction prices q. The agent the assesses the expected utility using equation (7), and determines which candidate bundle has the highest expected utility (or benefit) (i.e. Step 222 is repeated). The agent 27 then places bids in the set of optimal auctions which appear in this bundle in which it does not currently hold the highest bid (i.e. Step 224 is repeated). The algorithm's 28 behaviour in these two cases will now be explored.

Firstly, assume the reverse auction 22b for {5la} has a leading offer of £210 held by another party. This gives an expected closing price of £195 if the agent 27 continues to participate in it. Hence, the expected profit of the bundle the agent 27 is currently pursuing is now £50. It is clearly possible to do better than this as the profit from the sub-bundle {c,5sfo} is £60, and the agent 27 currently holds a bid in auction c, so there is no risk in withdrawing from the other auctions. Applying equation (8) to all of the sets of auctions in the candidate set shows that this is indeed the optimal bundle to commit to now: there is no way of profitably satisfying {5la}, hence the agent 27 no longer pursues this aim.

If the agent 27 held no bids in any auction, equation (5) shows that the agent 27 would choose to bid for the bundle {f,d,5sfo}, giving an expected profit of £70. However, equation (8) gives an expected profit of £44. The additional cost of de-committing from auction c and hence risking accidental purchase is not worth the potential gain of swapping to a different bundle.

Now assume that the agent 27 holds the leading offer of £210 in the reverse auction 22a for {5la}, giving an expected closing price of £200 if the agent 27 continues to participate in it. The expected profit of the current bundle is therefore £55, which is still less than the expect profit (according to (5)) of the sub-bundle {c,5sfo}. However, applying equation (8) indicates that the agent 27 should not switch to this bundle. The probability of the agent 27 accidentally winning {5la} is 1/3, resulting in receiving a payment of £210 but needing to purchase {la} from a fixed-price competitor at market value which is £260. The expected cost of this risk (16.7) is significantly higher than the benefit of de-committing (5), so the current bundle should be maintained.

However, applying the rewrite rules 30 and equation (8) to alternative options shows that there is a better alternative. Rather than using c to generate sfo, it can be used together with h to generate la at an expected cost of £200. f and d can then-be used to generate sfo in a more cost-effective way. Hence, the optimal bundle to commit to now is {c,h,5la,f,d,5sfo}. This gives an expected profit of £70.

These examples demonstrate the different flays in which the algorithm can react to situations. The agent 27 implementing the algorithm 28 will often remain bidding for a certain bundle of goods and contracts. However, if this is no longer expected to be optimal according to equation (8), it will adopt an alternative approach. This may involve withdrawing from part of the bundle by de-committing from a reverse auction together with associated forward auctions. Alternatively, it may involve remaining committed to all reverse auctions but adjusting the set of forward auctions being used to purchase the required components. Finally, it may involve withdrawing completely from all auctions. At each stage, the agent's 27 decision is determined by its estimate of the expected utility of pursuing different options.

Finally, once the auctions have closed, the method 200 may include the further (optional) Step 226 of updating the likelihood models 44 of the forward and reverse auctions which have been considered by the agent 27.

Having described preferred embodiments of the present invention, it is to be appreciated that the embodiments in question are exemplary only and that variations and modifications such as will occur to those possessed of the appropriate knowledge and skills may be made without departing from the spirit and scope of the invention as set forth in the appended claims. For example, only service composition has beer discussed in detail. However, the invention could be utilised for forming composite goods (for instance, the manufacture of computers by the purchasing of individual components such as mother boards, displays, memory etc), or a combination of goods and services. The invention may also be applied to other types of forward and reverse auctions other than English forward and reverse auctions, such as sealed bid auctions and Dutch auctions, amongst others.

1. A method of determining a bidding strategy for the simultaneous purchase of at least one individual service component from one or more on-line forward auctions, and the provision of a composite service requested by an on-line reverse auction, the method comprising:
identifying forward auctions selling the at least one individual service component;
identifying a reverse auction requesting a composite service comprising the at least one service component;
determining a plurality of possible combinations of the identified forward and reverse auctions;
estimating the expected benefit of bidding in each of the plurality of possible combination of auctions by use of likelihood models, wherein a reverse auction is modelled as a negative forward auction, and each likelihood model establishes the likelihood of a particular bid succeeding in a given auction; and
selecting the combination of auctions which provides the highest expected benefit, for use as the bidding strategy.

2. A method according to claim 1, wherein the determining step comprises determining all possible combinations of the identified forward and reverse auctions.

3. A method according to claim 1, further comprising determining rules for defining which ones of individual service components form the composite service requested in the reverse auction.

4. A method according to claim 1, wherein the one or more on-line forward auctions comprises an English auction.

5. A method according to claim 1, wherein the one or more on-line forward auctions comprises an offer for the sale of a service component at a fixed-price.

6. A method according to claim 1, wherein the on-line reverse auction comprises a reverse English auction.

7. A method according to claim 1, wherein the on-line reverse auction comprises a request for the purchase of a composite service at a fixed-price.

8. A method according to claim 4, wherein likelihood models for the forward and reverse auctions, a, are given by a price distribution Pₐ:Z [symbol] [0,1] which represents the belief that auction a will close at price p with probability Pₐ(p), where Z is a real number.

9. A method according to claim 5, wherein the likelihood models for the forward and reverse auctions, a are given by a price distribution Pₐ(x)=1 if x=p, and 0 otherwise, which represents the belief that auction a will close at price p with 100% probability.

10. A method according to claim 1 any preceding claim, wherein the considering step further comprises removing from the plurality of possible combinations of auctions, sets of auctions for which the individual service components do not match the composite service request, such that each of the plurality of possible combination of auctions contains a reverse auction and at least one forward auction.

11. A method according to claim 10, wherein the removing step is carried out prior to placing a bid in the one or more forward auctions and making an offer in the reverse auction.

12. A method according to claim 1, wherein the estimating step comprises estimating the future benefit, E_{c}, of bidding in a set of auctions B, given a set of observed prices q, and given that active bids are held in auctions A, by the following algorithm:
$${E}_{c} ( B , A , q ) = E ( B , A , q ) + {\sum }_{B ⋐ S ⋐ A ⋃ B} {P}_{ret} ( S , A , q ) [ ( V ( S ) - V ( B ) ) - {\sum }_{a ∈ S / B} q ( a ) ] ,$$
S is the set of auctions in A_{χ}E(B,A,q) is the expected benefit of the set of auctions B, given a set of observed prices q, and given that active bids are held in auctions A, Pᵣₑₜ(S,A,q) is given by (F_{A\S}(q+1)P_{S\B}(q))/F_{A\B}(q) where Fₐ is the probability that the auctions a will close at or above the prices q, Fₐ(p) is given by 3_{p′∃p}Pₐ(p′), V(S) is the valuation of the set of auctions S, and V(B) is the valuation of a given set of services in B.

13. A method according to claim 10, wherein the estimating step comprises estimating the future benefit, E_{c}, of bidding in a set of auctions B, given a set of observed prices q, and given that active bids are held in auctions A, by the following algorithm:
$${E}_{c} ( B , A , q ) = E ( B , A , q ) + {\sum }_{a ∈ A / B} {P}_{win} ( a , q ( a ) , q ( a ) ) ( v ( a ) - q ( a ) ) ,$$
where S is the set of auctions in A_{χ}B, E(B,A,q) is the expected benefit of the set of auctions B, given a set of observed prices q, and given that active bids are held in auctions A, P_{win} is the probability of a bid at price p>=q winning if the price in auction a is q, and v(a) is the exogenous value of a service a.

14. A method according to claim 12, wherein the expected benefit E(B,A,q) is given by the following expression:
E(B,A,q)=V(B)−C(B1A, q)−C(B\A, q+1)
where the function C(S, q′) is the expected cost of winning the auctions S at prices greater than or equal to q′, where C(S, q′) is given by
$${\sum }_{{p}^{′} \geq {q}^{′}} {\sum }_{a ∈ S} {P}_{win} ( a , {p}^{′} ( a ) , {q}^{′} ( a ) ) {p}^{′} ( a ) .$$

15. A method according to claim 14, wherein the values V(B) of the services in the set of auctions B are calculated prior to placing bids in the forward and reverse auctions.

16. A method according to claim 1, further comprising obtaining the closing prices of specific auctions in forward and reverse auctions, and creating a likelihood model for each auction from the closing price information.

17. A method according to claim 16, further comprising updating the likelihood models with the results of the implemented bidding strategy.

18. A method of simultaneously bidding in forward and reverse auctions using a bidding strategy, the method comprising determining the bidding strategy according to any preceding claim, and placing the minimal bids in the optimal set of auctions to take the lead in the set of auctions in which leading bids are not held.

19. A system for determining a bidding strategy for the simultaneous purchase of at least one individual service component from one or more forward on-line auctions, and the provision of a composite service requested by an on-line reverse auction, the composite service comprising at least one individual service component, the system comprising: likelihood models for the forward and reverse auctions, each model being arranged to determine the likelihood of a particular bid succeeding in a given auction; and processing means arranged to access the likelihood models; to consider a plurality of possible combinations of forward and reverse auctions; to estimate the expected benefit of bidding in each of the plurality of possible combination of auctions by use of the likelihood models, wherein a reverse auction is modelled as a negative forward auction; and to select the combination of auctions which provides the highest expected benefit, for use as the bidding strategy.

20. A system according to claim 19, where the plurality of possible combinations of forward and reverse auctions comprises all possible combinations of forward and reverse auctions.

21. A system according to claim 19, wherein the processing means is further arranged to remove from the possible combinations of auctions, sets of auctions for which the individual service components do not match the composite service request, such that each possible combination of auctions contains a reverse auction and at least one forward auction.

22. A data carrier comprising a computer program arranged to configure a computer to implement the method of claim 1.

23. A method of determining a bidding strategy for the simultaneous purchase of at least one individual service component from one or more forward auctions, and the provision of a composite service requested by a reverse auction, the method comprising:
identifying forward auctions selling the at least one individual service component;
identifying a reverse auction requesting a composite service comprising the at least one service component;
determining a plurality of possible combinations of the identified forward and reverse auctions;
estimating an expected benefit of bidding in each of the plurality of possible combination of auctions; and
selecting a combination of auctions for bidding in to increase a total expected benefit.

24. A system for determining a bidding strategy for the simultaneous purchase of at least one individual service component from one or more forward auctions, and the provision of a composite service requested by a reverse auction, the composite service comprising at least one individual service component, the system comprising: likelihood models for the forward and reverse auctions, each model being arranged to determine the likelihood of a particular bid succeeding in a given auction; and processing means arranged to access the likelihood models; to consider a plurality of possible combinations of forward and reverse auctions; to estimate an expected benefit of bidding in each of the plurality of possible combination of auctions by use of the likelihood models; and to select a combination of auctions for bidding in to increase a total expected benefit.
